(19) United States
(12) Patent Application Publication
(10) Pub. No.: US 2016/0358211 A1
(43) Pub. Date: Dec. 8, 2016

(54) PERSONALIZED RECOMMENDATION SYSTEM FOR COUPON DEALS

(71) Applicant: SAP SE, Walldorf (DE)

(72) Inventor: Yi HUANG, Singapore (SG)

(21) Appl. No.: 14/731,375

(22) Filed: Jun. 4, 2015

(51) Int. Cl. G06Q 30/02

(52) U.S. Cl. CPC G06Q 30/0255; G06Q 30/0269

(57) ABSTRACT

A framework for generating recommendations of deals to users is described herein. A purchase data set which includes deals purchased by of users is provided. The purchase data is analyzed to generate keyword association rules. The keyword association rules indicates purchase behaviour of users. Weights are assigned to valid deals. The weights are based on keyword association rules, keywords of valid deals and keywords of deals of a target user's purchase history. The weights are used to derive relevancy factors of valid deals which are personalized to the user. This enables personalized recommendations to be generated for a target user.

### TECHNICAL FIELD

The present disclosure relates to computer systems, and more specifically, to a framework for providing personalized recommendations for coupon deals based on keyword association.

### BACKGROUND

The advent of e-commerce platforms has created vast new markets and endless opportunities. For example, the number of on-line transactions has increased tremendously on a world-wide basis. On-line commerce platforms have invested heavily to improve consumers' shopping experience. Such experience improvements include, for example, ease of navigation to find items of interest and various easy checkout payment options. Another consumer experience improvement relates to marketing deals to consumers.

Conventional marketing campaign approaches for deals involve pushing deals to subscribers or consumers to increase exposure, in hopes of increasing sales. Such marketing techniques may include mass distribution of deals, such as by electronic or non-electronic mailing. However, such conventional mass marketing approaches do not differentiate customers' desires or needs, making such approaches ineffective or less effective. In other words, such marketing approaches are not personalized to the individual consumer. For example, mass marketing approaches usually end up spamming consumers. Furthermore, such approaches inundate consumers with unnecessary or irrelevant information, such as non-interesting deals, while obscuring those that may be relevant.

From the foregoing discussion, it is desirable to provide effective marketing of deals which are relevant to individual consumers.

### SUMMARY

A framework for generating recommendation of deals to users is described herein. In accordance with one aspect, the framework includes a computer-implemented method. The method includes analyzing a purchase data set containing purchased deals of users to generate keyword association rules. Target weights for valid deals available for purchase by a target user are computed. The target weights are based on keyword association rules, purchased deals by the target user, and valid deals. Personalized recommendations of valid deals are generated to the target user based on relevancy factors of the valid deals.

In another aspect, a deals recommendation system is disclosed. The deals recommendation system includes a data source. The data source includes a purchase data set containing purchased deals of users. The system includes an analyzer. The analyzer analyzes the purchase data set to generate keyword association rules. Target weights are computed for valid deals for purchase by a target user based on the keyword association rules, purchase history of deals purchased by the target user, and valid deals. Personalized recommendations of valid deals to the target user are generated based on relevancy factors of the valid deals.

In yet another aspect, a non-transitory computer-readable medium having a stored thereon program code is disclosed. The program code is executable by a computer for generating recommendation of deals which includes providing a data source. The data source includes a purchase data set containing purchased deals of users. The purchase data set is analyzed to generate keyword association rules. This includes determining keyword pairs of deals purchased by users in the purchase data set. For each keyword pair, support and confidence values are determined. The support value indicates a support for the first keyword of the keyword pair while the confidence value indicates the confidence of the second keyword in the keyword pair given the first keyword of the keyword pair. Target weights are computed for valid deals available for purchase by a target user based on keyword association rules, purchased deals by the target user, and valid deals. Personalized recommendations of valid deals to the target user are generated based on relevancy factors of the valid deals.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 shows a simplified diagram of an exemplary recommendation environment;

FIG. 2 shows a block diagram of an embodiment of a recommendation system; and

FIG. 3 shows an embodiment of a process for computing word associations from all transactions or purchases.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework is provided for generating recommendations for on-line deals, such as on-line coupon deals. The recommendations are provided to, for example, consumers. Consumers may include subscribers of on-line deals or users of applications (Apps) of online platforms providing deal recommendations. Providing recommendations to other types of consumers may also be useful. The framework identifies behaviour of purchasers of on-line deals. The purchasers, for example, are subscribers who have previously purchased on-line deals. Based on the behaviour of the purchasers, personalized recommendations are generated to the subscribers. In one implementation, the framework generates keyword association rules based on the behaviour of the purchasers to generate recommendations to the subscribers of coupon deals. By using the keyword association rules, personalized recommendations of coupon deals can be provided to subscribers.

In one implementation, the framework determines the behaviour of purchasers from a data set containing historical purchases of users or subscribers of on-line deals. The data set may be from a single or specific on-line deal provider. Deriving the data set from multiple on-line deal providers may also be useful. The data set is analyzed to generate keyword association rules, which are indicative of behaviour of purchasers. The keyword association rules are used to generate personalized recommendations of on-line deals to users or subscribers. The data set may be updated with new deal purchases as they are made by the purchasers. Keyword association rules may be updated using the updated data set. Updates, for example, may be on a periodic basis, such as weekly, monthly or other periods. Other configurations of updates may also be useful.

The framework may generate recommendations to users when there is a change in status of the system. For example, recommendations may be made when a user makes a purchase. Additionally or in the alternative, recommendations may be triggered when a new deal is added into the system. The recommendations may be triggered specifically to a user once a purchase is made or generally when the system is updated. Other configurations of triggering recommendations may also be useful. For example, the recommendations may be triggered periodically, such as on a daily basis. Triggering the recommendations at other time periods may also be useful.

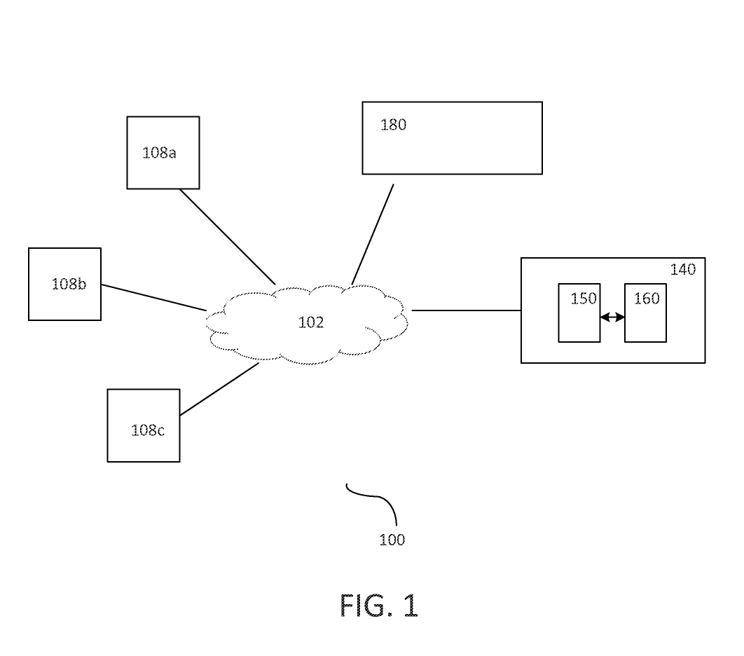

FIG. 1 shows a simplified diagram of an exemplary environment 100. The environment 100, for example, includes a recommendation system 140. The recommendation system may act as a server and operate in a networked environment with user devices 108a-108c. For example, the recommendation system may have a distributed architecture, such as a client-server architecture. Other types of architectures may also be useful. A server may include one or more computers or servers. A computer includes a memory and a processor. Various types of computers may be employed for the server. For example, the computer may be a mainframe, a workstation as well as other types of processing devices. The memory of a computer may include any memory or database module. The memory may be volatile or non-volatile types of non-transitory computer-readable media such as magnetic media, optical media, random access memory (RAM), read-only memory (ROM), removable media, or any other suitable local or remote memory component. The computers or servers are connected through a communication network such as internet, intranet, local area network (LAN), wide area network (WAN) or a combination thereof. The servers, for example, are part of the same private network. The servers may be located in single or multiple locations.

As for user devices 108a-108c, the devices may be any local computing devices with, for example, a local memory and a processor. The memory may be volatile or non-volatile types of non-transitory computer-readable media such as magnetic media, optical media, RAM, ROM, removable media, or any other suitable local or remote memory component. Various types of processing devices may serve as an end-user device. For example, the end-user device may be a personal computer (PC), a tablet PC, a workstation, a network computer or a mobile computing device, such as a laptop, a tablet or a smart phone. Other types of processing devices may also be used.

The various components of the network may be connected through a communication network 102. For example, components of the network may be connected by internet, intranet, LAN, WAN or a combination thereof. Other type of networks or network connections may also be useful. For example, the network connections may include a WIFI or a 3G/4G/LTE connection. In some cases, the network may be a cloud.

A user may connect to the server using a user device. For example, the user device may include a browser for connecting to the analysis system. The user device may be referred to as the client side while the analysis system may be referred to as the server side. Other types of configurations for the analysis system may also be useful.

The recommendation system may be a web-based system. For example, users may access the deals system using a browser on the user devices. In one implementation, users may perform a managerial role. For example, the user may be a manager of the recommendation system by managing its operation. In some cases, users which are subscribers may access the recommendation system to provide or change the settings related to the personalized recommendations.

The recommendation system, in one implementation, includes a data source 150 and a recommender or analyzer 160. The recommendation system may include other components.

The data source includes a memory for storing data used by the analyzer. The data source may store data used and generated by the analyzer. The data source may be a database. The database, for example, may be a relational database or Structured Query Language (SQL)-based database, such as SAP HANA database from SAP SE. Other types of databases may also be useful.

In one implementation, the data source includes a subscriber data set. The subscriber data set includes subscriber information. The subscriber information includes information of purchases made by the subscribers. Subscriber information may include other information, such as contact information, personal information such as gender, age and interests. Other subscriber information may also be included, such as time stamp and/or types of purchases. The subscriber data set includes subscriber information of subscribers of a specific on-line deal provider. In some implementations, the subscriber data set may include subscriber information of multiple on-line deal providers.

The subscriber data set is used by the recommendation system 140. For example, the recommendation system analyzes the subscriber data set and generates keyword association rules which are indicative of the purchasers' behaviour patterns. The keyword association rules may be stored in the data source. Storing the keyword association rules in other storage locations may also be useful.

The recommendation system applies keyword association rules to generate recommendations for the subscribers. The recommendations are personalized for every subscriber. In one implementation, the personalized recommendations are based on keyword association rules as well as the subscribers' personal purchasing history, if applicable. For example, when a subscriber is a new subscriber without any purchasing history, recommendations may be made based on the volume of valid deals sold. For example, valid deals which have the most or highest number of purchases by the users, are recommended. Other techniques for providing new user recommendations may also be useful, including traditional mass mailing techniques.

The system may generate recommendations to users when there is a change in status of the system. For example, recommendations may be made when a user makes a purchase. Additionally or in the alternative, recommendations may be triggered when a new deal is added into the system. The recommendations may be triggered specifically to a user once a purchase is made or generally when the system is updated. Other configurations of triggering recommendations may also be useful. For example, the recommendations may be triggered periodically, such as on a daily basis. Triggering the recommendations at other time periods may also be useful.

In one implementation, the recommendations to subscribers may be saved. For example, the recommendations may be saved in the data source. The saved recommendations may be subsequently analyzed. For example, analytics may be performed to determine the accuracy of the recommendations. The analytics may be used to adjust weights to improve recommendation accuracy of the system.

As described, the recommendation system contains both a data source and an analyzer. The data source and analyzer may be contained in a server. For example, the data source and analyzer may be contained in a single server, which serves as the recommendation system server. In one implementation, the recommendation server may be a relational database or SQL-based database, such as SAP HANA, which contains both the data source and analyzer. Alternatively, the data source and analyzer may be contained in separate servers. Other configurations of the recommendation system may also be useful.

The environment may include an on-line deals system 180 for providing a list of on-line deals available for subscribers to purchase. The on-line deals system may be a web-based system. For example, the subscribers may access the deals system using a web browser on the user devices.

The recommendation system and on-line deals system may be an integrated system. Providing a stand-alone recommendation system which interacts separately with the deals system may also be useful. Other configurations of recommendation and deals systems may also be useful. For example, the recommendation system may a dedicated recommendation system of an on-line deals system. Alternatively, the recommendation system may provide recommendations as a service for a plurality of on-line deals systems.

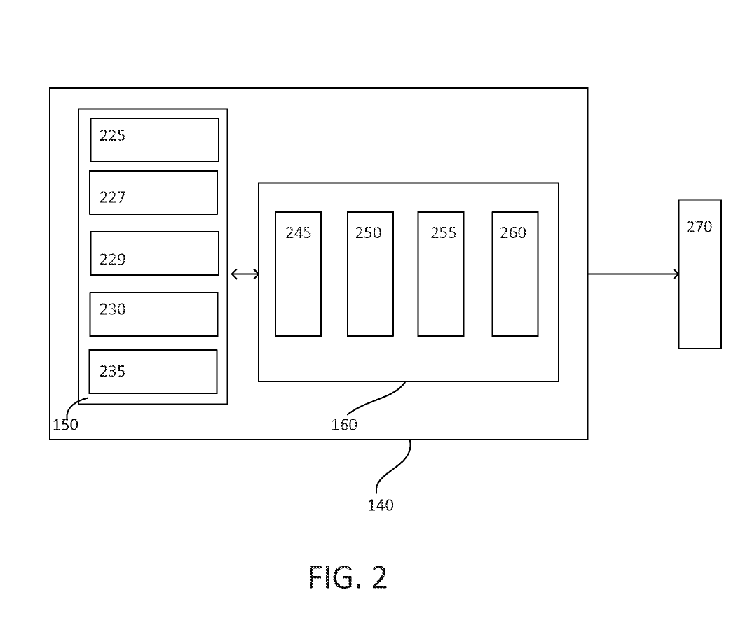

FIG. 2 shows a block diagram of an embodiment of the recommendation system 140. The recommendation system, for example, may be a web-based system. The web-based system may be accessed using a web browser on a user device. Access to the system may be through an App. Other techniques for accessing the system may also be useful.

In one implementation, a user may be an administrator of the system. The administrator may access the system to maintain the system. For example, the administrator may run analytics, update the keyword association rules, or for other system maintenance purposes. For example, the administrator may change parameters of the systems, such as how many deals to recommend, how often to recommend deals as well as weights for association rules. Some maintenance functions may be configured to be automatically performed.

Recommendations of coupon deals may be provided to the users who are, for example, subscribers. The recommendations may be provided to subscribers through electronic mail. In other cases, a subscriber may initiate an App or go to the website of a deals provider to search for available deals. The system may provide recommendations to the user when the App or site is accessed. Other techniques for providing the recommendations to the subscribers may also be useful. The subscribers may access the on-line deals service provider to purchase the coupon deals. The on-line deals service provider may be accessed by the subscribers using, for example, user devices.

As shown, the recommendation system includes a data source 150 and a recommender or analyzer 160. The recommendation system may include other components. The data source includes a memory for storing data. The data source stores various types of data. For example, the data source includes different data modules for different types of data. In one implementation, the data source includes data modules containing data used and generated by the analyzer. The data source may be a database. The database may be a relational database or SQL-based database. In one embodiment, the database may be a SAP LANA database from SAP SE. Other types of databases may also be useful.

As for the analyzer, it includes various modules for analyzing data to generate personalized recommendations 270 to subscribers. In one implementation, the analyzer includes a pre-processor module 245, a rules module 250, a weight module 255 and a recommendation module 260. Providing the analyzer with other modules may also be useful.

The pre-processor module pre-processes a data set in a subscriber purchase data module 225 of the data source. The data set, for example, is the subscriber purchase data set. The subscriber purchase data set includes, in one implementation, the subscriber purchase information. For example, the subscriber purchase data set includes deals purchased by the subscriber. The subscriber purchase data set, for example, is a table containing deals purchased by the subscribers. Table 1 below shows an exemplary format of a subscriber purchase data set:

TABLE 1

| Subscriber | Deal Time | Deal Category | Deal Description |
|---|---|---|---|
| User_ID | SECONDDATE | VARCHAR | VARCHAR |

As shown, the table includes Subscriber, Deal Time, Deal Category and Deal Description fields. The Subscriber field contains the user identification of the subscriber making the purchase, the Deal Time field indicates the time which the deal was made, the Deal Category field is the category of the deal and the Deal Description field is a description of the deal purchased. Providing other fields in the table may also be useful.

In some cases, the Deal Category field may be manually provided. For example, the categories of deals may be manually defined by the user of the recommendation system. The various categories of deals may include, for example, dining, wellness/health, products, activities and travel. Other category types or granularity may also be useful. Table 2 below illustrates an example of the categories for deals:

TABLE 2

| Category | Deal Name |
|---|---|
| Dining | $5.50 for Delifrance All Time Favourite Classic Sandwich & |
| | Beverage Set (Worth up to $10.40) at 27 Locations |
| Dining | 9-Course Chinese Cuisine Set: $138 for 6 Pax at Owen Seafood |
| | Restaurant at The Grandstand in Turf City (Worth $298) |
| Wellness | $24 for Classic Manicure and Pedicure with Foot Soak + Foot |
| | Scrub at The Professionails in Orchard (Worth $60) |
| Wellness | 3 Hour Spa Indulgence: $40 for Body Massage + Diamond Peel |
| | Facial + More at Z Beauty Boutique in Clementi (Worth $380) |
| Products | One 1 TB Portable 2.5″ USB HDD Set at $87.90 (Worth $154). 4 |
| | Colours Available. |
| Products | Eurobed Cambridge Pocketed Mattress, with Delivery by Four Star |
| | Industries at $199 (Worth $399). More Options Available. |
| Activities | Sentosa: $29 for Admission to Underwater World + Dolphin |
| | Lagoon + Merlion Tower + Songs of the Sea (Worth $47.90) |
| Activities | $25 for Four 60 min Yoga Classes at Real Yoga in 4 Locations |
| | (Worth $180) |
| Travel | Phuket: $310 per pax for 3D2N 4-Star U Sunsuri Phuket Stay + |
| | Tiger Airways Flight + Airport Transfer (Worth $550) |
| Travel | Ho Chi Minh: $189 per pax for 3D2N Hotel Stay with Breakfast + |
| | Vietnam Airlines Flight + Airport Transfer (Worth $355) |

As for user information, a user table may be provided. For example, the user table may be contained in a user data module 229 of the data source. The user table includes user information, such as user id, user name, age, gender, contact or account information, as well user interest. Other types of user information may also be provided. The user id of the subscriber purchase data may be cross-referenced with the user table to obtain user information.

The subscriber purchase data set includes a specific on-line deal provider. In some implementations, the subscriber data set may include the subscriber information of multiple on-line deal providers. Other configurations of subscriber data set may also be useful.

In one embodiment, the pre-processor module pre-processes the Deal Description field to extract relevant information. In one embodiment, the deal description field of the subscriber purchase data set is pre-processed to identify keywords. For example, keywords in the description field are identified. In one implementation, the keywords are nouns. Other types of keywords may also be useful. Keywords are used in determining keyword association rules. Various techniques may be employed to separate the key words from non-keywords, such as nouns from non-nouns. For example, when a deal is listed, the seller or administrator may identify or tag nouns or keywords from non-nouns or non-keywords in the description. Alternatively, automated techniques may be employed to identify nouns from non-nouns. For example, a text analyzer may be employed to analyze the description to identify keywords. In one implementation, automated text analysis may be performed using SAP HANA text analysis tool. Other techniques or text analysis tools for identifying keywords or nouns may also be useful.

The keywords in the Deal Description field may be identified and inserted into a new field in the data set, such as a keywords field. For example, nouns may be identified and inserted into a nouns field in the data set. The description field may remain unchanged. The data set with the new keyword filed, for example, serves as a modified data set. Other configurations for pre-processing the Deal Description field may also be useful.

In one implementation, when a subscriber makes a new purchase, the purchase is added to the subscriber purchase data set. The pre-processor may be initiated to pre-process the information of the new purchase. In other cases, the pre-processor may be initiated on a periodic basis for updating. Other configurations of pre-processing the data set may also be useful.

The rules module 250 processes the modified subscriber purchase data set to generate keyword association rules. Generating keyword association rules includes defining various components. For example, the components may include the set of users U, set of deals D and set of words W in the Deal Description fields of the deals in the set of deals D.

The set of users U is defined as follows:

U={(u₁, . . . uₗ, . . . u_{L}} (1≦l≦L),

where

L is the total number of users or subscribers in the modified subscriber purchase data set.

The set of deals D is defined as follows:

D={d₁, . . . dₙ, . . . d_{N}} (1≦n≦N),

where

N is the total number of deals in the modified subscriber purchase data set.

The set of words W is defined as follows:

Wₙ={ω₁ⁿ, . . . ω₂ⁿ, . . . ω_{θ(n)}ⁿ},

where,

Wₙ is the set of words in the deal description deal n (dₙ), and

θ(n) is the number of words for dₙ. The words, for example, are nouns in the Deal Description field. For example, the words may be contained in the nouns field of the modified subscriber purchase data set.

In one embodiment, the rules module computes keyword associations from all transactions or purchases in the modified subscriber purchase data set. This produces keyword association rules. The keyword association rules, for example, are performed off-line. The keyword association rules may be updated periodically. For example, the rules may be updated on a daily, weekly or monthly basis.

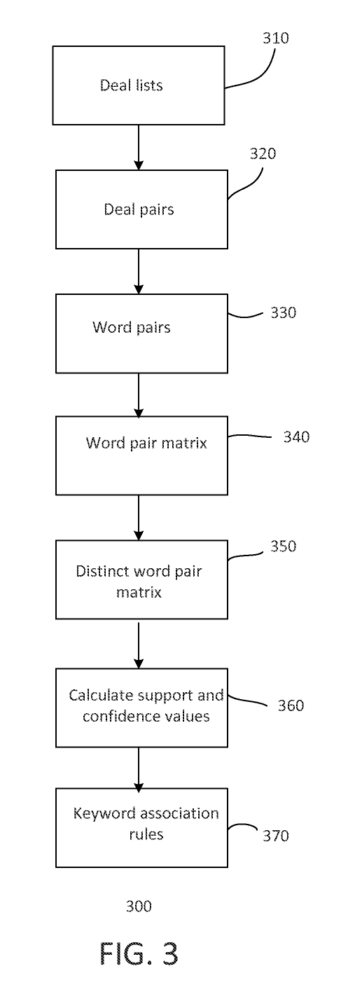

FIG. 3 shows an embodiment of a process 300 for computing the keyword associations from all transactions or purchases. At step 310, a specific list of deals (deal list) purchased by the subscribers or users is determined. For example, a deal list for each user is determined. The deals of a deal list may be sorted based on time of purchase. In one embodiment, the deals are sorted by date in ascending order to generate a subscriber or user deal list.

In one embodiment, a user deal list D₁ purchased by a user u₁ is computed by selecting the list of historical deals. The deal list may be defined as follows:

D₁={d₁^{l}, . . . , d₂^{l}, . . . d_{δ(l)}^{l}} (1≦l≦L),

where

δ(l) is the number deals purchased buy user u₁.

In the case of a deal list sorted by date in an ascending order, the most recent purchase is represented by d_{δ(l)}^{l} while the oldest purchase is represented by d₁^{l}.

At step 320, a set p of all possible deal pairs of a deal list is computed from the user deal list. The set of deal pairs from the deal list of user u₁ may be defined as follows:

p_{(s,t)}^{l}={dₛ^{l}, dₜ^{l}}in Dₗ where 1≦s<t23 δ(l).

With respect to a deal pair p_{(s,t)}^{l} in the set p, the first deal dₛ^{l} is purchased before the second deal dₜ^{l}. This ensures that s<t.

At step 330, possible word pairs for deal pairs in the set p are determined.

The set of deal pairs p_{(s,t)}^{l} is determined. For example, for every deal pair p_{(s,t)}^{l}, all possible word pairs are computed. Word pairs p_{( k,m)}^{(s,t)} may be defined as follows:

p_{(k,m)}^{(s,t)}={ωₖ^{s}, ωₘ^{t}},

where

ωₖ^{s}belongs to deal dₛ^{l} , and

ωₘ^{t} belongs to deal dₜ^{l}.

Since different deals may contain the same words, ωₖ^{s} and ωₘ^{t} can be the same.

The steps 310, 320 and 330 are repeated until all the subscribers or users are processed. This produces all possible word pairs (e.g., R represents number of word pairs) for all deals purchased in all the deal lists of the users. At step 340, the word pairs are aggregated into a matrix M. For example, all possible word pairs for all deals in all user deal lists are aggregated into the matrix M. In one implementation, every row of M corresponds to a word pair. For example, M is an R×2 matrix. The matrix M may include word pairs that are the same. For example, multiple rows of M may be the same.

At step 350, distinct word pairs of M are extracted to form a unique matrix M̅. For example, a row in M̅ corresponds to a unique word pair. For example, V number of unique word pairs are in M. An element of M̅ may be defined as M̅_{v,e}, where v is the row number of the M̅ and c is the column number of M̅. For example, M̅_{2,2} correspond to the element in the second row and second column of M̅. The occurrence of a unique word pair is counted and represented by oᵥ, which is the number of occurrence in M̅ of the unique word pair in the v^{th} row ofM̅. The value oᵥ may be inserted or included as a column in M̅. For example, oᵥ may be a third column in M̅.

The elements M̅_{v,1} and M̅_{v,2} correspond to the first and second words in the unique word pair in the v^{th} row of M̅. The number of times that M_{v.1}, occurs in the first column of M is counted. This count is represented as c(_{v,1}).

At step 360, support and confidence values of word pairs in M̅ are calculated. The support value indicates the level of support for the word M̅_{v,1} the matrix for the first word of a unique word pair. For example, the support value for M̅_{v,1} is computed. The support value, in one implementation, is computed using equation 1 as follows:

$$supp = \frac{{c}_{( v , 1 )}}{R} \qquad Equation ( 1 )$$

where

R is the number of all keyword pairs, including non-unique pairs (e.g., rows in matrix M).

As for the confidence value, it indicates the confidence of the word M̅_{v,2} occurs given the word M̅_{v,1}. The confidence value, in one implementation, is computed using equation 2 as follows:

$$conf = \frac{{o}_{v}}{{c}_{( v , 1 )}} \qquad Equation ( 2 )$$

A general word pair table with support and confidence values may be generated.

At, step 370, word pairs which occur with a high frequency are selected. High frequency is based on, for example, support multiplied by confidence. In one implementation, top x percent of word pairs in M̅ with the highest values of support multiplied by confidence is selected. For example, the top 5% of word pairs in M̅ with the highest value of support multiplied by confidence is selected. Selecting other top percentages may also be useful. The selected word pairs form a keyword association rules table. Table 3 below shows an exemplary embodiment of a word pair table with support and confidence values:

TABLE 3

| WORD1 | WORD2 | SUPPORT | CONFIDENCE |
|---|---|---|---|
| buffet | buffet | 0.001097 | 0.041530 |
| dinner | buffet | 0.000273 | 0.043138 |
| hotel | buffet | 0.000114 | 0.038511 |
| massage | buffet | 0.000137 | 0.020783 |
| massage | massage | 0.000124 | 0.018894 |
| body | massage | 0.000103 | 0.019071 |
| Swarovski | Swarovski | 0.000052 | 0.018473 |
| treatment | body | 0.000060 | 0.016164 |
| playground | playtime | 0.000035 | 0.024618 |
| beauty | massage | 0.000044 | 0.019258 |
| spa | body | 0.000053 | 0.014788 |
| facial | massage | 0.000026 | 0.019929 |
| necklace | Swarovski | 0.000022 | 0.019577 |
| Coach | Coach | 0.000022 | 0.009390 |
| therapy | hair | 0.000017 | 0.007879 |

The table above, for example, provides keyword association rules. The table provides an insight to the behavioural buying patterns of purchasers. For example, it can be interpreted from the table that the purchasers who have bought a deal containing “WORD1” in a deal description also tend to buy another deal containing “WORD2”. The high support and confidence level of a word pair indicates that 1) there are a lot of deals in the transactions having “WORD1” in the deal description, and 2) purchasers who previously bought a “WORD1” deal tend to buy a “WORD2” deal.

As illustrated, the word pair {buffet, buffet} appears the most or has the highest support multiplied by confidence value. This indicates that the purchasers who have bought a buffet deal are likely to buy another or different buffet deal. Also, the first four words “buffet”, “dinner”, “hotel” and “massage” under the “WORD1” column appear with the word “buffet” under the “WORD2” column the most. This indicates that the purchasers who bought these types of deals tend to buy buffet deals in the future. This makes sense because inversely, other buffet deals also have these four words in their description. Additionally, as shown, the purchasers who have bought massage deals also tend to buy buffet deals. The same observation holds for “treatment”, “body”, “facial”, “hair”, “spa” and “massage”, e.g., people who bought body massage deals will buy facial spa deals later, meaning people buy beauty deals repeatedly. As shown, the repeated purchases are not limited to service deals (e.g., dining, beauty), but also extend to products deals such as Swarovski and Coach products which are repeated in the purchasers' buying patterns.

The weight module 255 generates weights for deals. In one implementation, the weight module generates weights for available deals. For example, the weights are generated for different deals which are available for purchase by users. On-line deals, for example, may have expiration dates and thus are invalid. The weights are provided for valid deals and the recommendations are made for valid deals,

Valid deals are determined by the recommendation system. For example, the weight module determines valid deals available for sale by the deals provider. The set of valid deals D_{T} may be defined as below:

D_{T}={d₁^{T}, . . . d₂^{T}, . . . , dδ(T)^{T}}

where

δ(T) is the number of valid deals at time T.

To compute the weights for deals to be recommended to a user, nouns in the description of valid deals are selected. For example, the valid deals are pre-processed to extract the nouns from the description in the Deal Description field. The pre-processing may be performed using the pre-processor module, as previously described. Other configurations of pre-processing the valid deals may also be useful.

To determine the weights, words contained in the deals are selected. For example, the nouns in the Deal Description fields of the available deals are selected. In one implementation, for every deal, all words in the Deal Description field are selected. For example, for every available deal dₙ ∈ D_{T}(1≦n≦δ(T)), all of the nouns in the description field are selected. The words or nouns in the Deal Description field may be denoted as follows:

Wₙ={ω₁ⁿ, . . . ω₂ⁿ, . . . ω_{δ(n)}ⁿ},

where δ(n) is the number of words in deal dₙ.

The words in the purchase history of a user uₗ are selected. For example, all words in the set of deals Dₗ purchased by uₗ are selected. The set of words Wₗ of deals in the purchase history of uₗ may be defined as Dₗ as follows:

W₁={ω₁¹, . . . ω_{θ(1)}¹, ω₁², . . . ω_{θ(2)}², . . . ω₁^{δ(l)}, . . . ω_{θ(δ(l))}^{δ(l)}={ω}₁^{T}, . . . ωθ̅^{T}},

where

T is the time related to all past purchases of uₗ,

δ(l) is the number of deals purchased by uₗ, and

θ(δ(l)) is the number of words in the δ(l)−^{th} deal purchased by ul.

The number of elements or words in Wₗ in the purchase history is θ̅ , which is defined as follows:

θ̅=Σᵢ₌₁^{δ(l)}θ(i),

where

θ(i) is the number of words in the i^{th} deal, i is from 1 to δ(l).

The weight αₙ for deal dₙ is computed using equation 3 as follows:

αₙ=Σᵣ₌₁^{θ(n)} Σ_{q=1}^{θ̅C(ω}ᵣⁿ , ω_{q}^{T} Equation (3),

where

C(ω, ω′) as the confidence value of word pair {ω, ω′}.

The weights are assigned to the respective valid deal. For example, αₙ is assigned to dₙ, where n is from 1 to T. In some cases, the weights may be normalized. For example, the weight αₙ is normalized [0, 1] by dividing it by the maximum weight αₘₐₓ of the available deals in the set Dᵣ.

The recommendation module generates personalized recommendations of valid deals to user ul. The valid deals may be recommended based on relevancy factor γ. In one embodiment, γ is based on α. For example, the available deals in D_{T} are sorted in descending order according to equation 4 as follows:

γₙ=αₙ Equation (4).

The top deals with the highest or higher αₙ may be considered the most relevant deals for user uₗ in terms of keyword association. For example, the deals with the top 5-20 αₙ may be recommended to the consumer. Recommending other numbers of deals may also be useful.

In some implementations, generating the recommendations may further include factoring popularity of valid deals. Popularity of valid deals may include counting the volume of deals already purchased. In one implementation, the number of valid deals purchased are counted. The valid deals may be sort sorted by the quantity sold. For example, βₙ is the number of coupons sold for deal dₙ ∈ D_{T}. The number of coupon sold βₙ, may be normalized. For example, βₙ of each deal is divided by the maximum number of coupons sold βₘₐₓ in D_{T}. When further taking popularity of valid deals into consideration, the relevancy factor γ is in accordance with equation 5 as follows:

γₙ=αₙ+βₙ Equation (5).

In one implementation, the values γ of the available deals in D_{T} are sorted in descending order. The top deals are the most relevant deals for user uₗ in terms of keyword association and overall popularity. For example, the deals with the top 5-20 γₙ may be recommended to the consumer. Recommending other numbers of deals may also be useful.

The recommendation system, as described, generates personalized recommendations of valid deals to users. Generating personalized recommendations is based on keyword association rules. The keyword association rules are developed from purchase history of users. Personalization takes into account the personal purchase history of a target user and valid deals. For example, keywords from personal purchase history and valid deals are factored into the personalization process. To further improve accuracy, popularity of valid deals are also factored into personalizing recommendation of valid deals.

As described, the various modules of the recommendation system may be embodied as an application. For example, the various modules may be embodied as a software application. The modules may be integrated into an existing software application, as an add-on or plug-in to an existing application or as a separate stand-alone application. The source code of the application may be compiled to create an executable code. The codes, for example, may be stored in a storage medium such as one or more storage disks. Other types of storage mediums may also be useful.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method for recommending deals to users comprising:
analyzing a purchase data set containing purchased deals of users to generate keyword association rules;
computing target weights for valid deals available for purchase by a target user based on keyword association rules, purchased deals by the target user, and valid deals; and
generating personalized recommendations of valid deals to the target user based on relevancy factors of the valid deals.

2. The computer-implemented method of claim 1 wherein the purchase data set comprises:
a set of users U having purchased deals, where U={u₁, . . . uₗ, . . . u_{L}.} (1≦l≦L), the number of users is from 1 to L and 1 is the 1^{th} user;
a set of deals D purchased by users, where D={d₁, . . . dₙ, . . . d_{N}} (1≦n≦N), the number of deals is from 1 to N, and n is the n^{th} deal.

3. The computer-implemented method of claim 2 wherein analyzing the purchase data set comprises:
pre-processing the purchase data set to determine keywords from purchased deals, the pre-processing generates a set of keywords W, where
W={W₁, . . . Wₙ, . . . W_{N}} (1≦n≦N), and
Wₙ={ω₁ⁿ, . . . ω₂ⁿ, . . . ω_{θ(n)}ⁿ}, wherein
Wₙ is the set of keywords in a description of deal (dₙ) and
θ(n) is the number of words for dₙ.

4. The computer-implemented method of claim 3 wherein the keywords comprises nouns.

5. The computer-implemented method of claim 3 wherein analyzing the purchase data set comprises;
generating deal lists of users, wherein the deal list by user uₗ is defined as Dₗ={d₁^{l}, . . . d₂^{l}, . . . d_{δ(l)}^{l}} (1≦l≦L), where δ(l) is the number of deals purchased by user uₗ;
for each deal list,
determining all possible deal pairs within the deal list, where a set of deal pairs from the deal list Dl of user uₗ is defined as p(_{(s,t)}^{l}={dₛ^{l}, dₜ^{l}}, where 1≦s<t≦δ(l),
determining possible keyword pairs for each deal pair, wherein keyword pairs p_{(k,m)}^{(s,t)} may be defined as p_{(k,m)}^{(s,t)}={ωₖ^{s}, ωₘ^{t}}, ωₖ^{s} belongs to deal dₛ^{l}, and ωₘ^{t} belongs to deal dₜ^{l ; and}
aggregating the possible keyword pairs into a word pair matrix M, wherein elements and M_{v,1} and M_{v,2} correspond to the first and second keywords of a keyword pair in the v^{th} row of M.

6. The computer-implemented method of claim 5 comprises:
extracting unique keyword pairs of M; and
aggregating the unique keyword pairs into a unique keyword pair matrix M̅ wherein elements M̅ _{v,1} and M̅_{v,2} correspond to the first and second keywords of a unique word pair in the v^{th} row of M̅.

7. The computer-implemented method of claim 6 comprises counting the number of times that a keyword M̅_{v,1} occurs in the first column of M, wherein the count is equal to c_{(v,1)}.

8. The computer-implemented method of claim 7 comprises:
for each unique keyword pair in M̅,
computing the support value for the keyword pair, the support value indicates the support for keyword M̅_{v,1} which is
$$supp = \frac{{c}_{( v , 1 )}}{R} , \qquad$$
and
computing the confidence value for the keyword pair, the confidence value indicates the confidence of keyword M̅_{v,2} given keyword M̅_{v,1}, which is
$$conf = \frac{{o}_{v}}{{c}_{( v , 1 )}} ,$$
where oᵥ is the number of occurrence of the keyword pair in M, and
wherein the word pair, support value and confidence value form an association rule of the keyword pair; and
the association rule of each unique keyword pair forms keyword association rules.

9. The computer-implemented method of claim 7 wherein computing target weights comprises:
determining valid deals available for sale, wherein a set of valid deals is D_{T}={d₁^{t}, . . . d₂^{T}, . . . d_{δ(T)}^{T}}, where T is the number of valid deals at time T;
determining valid deal keywords from each valid deal, when keywords of a valid deal Vdₙ, where keywords VWₙ of a valid deal Vdₙ is VWₙ={Vω₁ⁿ, . . . Vω₂ⁿ, . . . Vω_{θ(n)}ⁿ},
where θ(n) is the number of words in valid deal Vdₙ;
determining keywords (target keywords) from a deal list (target deal list) of the target user, where a set of target keywords Wₗ of deals in the purchase history of the target user is Wₗ={ω₁¹, . . . ω_{θ(1)}¹, ω₁², . . . ω_{θ(2)}², . . . ω₁^{δ(l)}, . . . ω_{θ(δ(l))}^{δ(l)}}={ω₁^{T}, . . . ωθ̅^{T}},
where
T is the time related to all past purchases of the target user uₗ,
δ(l) is the number of deals purchased by uₗ, and
θ(δ(l)) is the number of words in the δ(l)−^{th} deal purchased by uₗ; and
for each valid deal Vdₙ, where n is from 1 to N.
calculating the target weight αₙ, where αₙ=Σᵣ₌₁^{θ(n)} Σ_{q=1}^{θ̅ C(ω}ᵣⁿ, ω_{q}^{T}), where C(ω, ω′) is the confidence value of word pair {ω, ω′}.

10. The computer-implemented method of claim 9 wherein computing the relevancy factors of valid deals for the target user comprises:
for each valid deal Vdₙ,
determining a quantity βₙ of Vdₙ sold,
normalizing βₙ to generate nβₙ,
normalizing αₙ to generate nαₙ, and
calculating the relevancy factor γₙ which is γₙ=nαₙ+nβₙ.

11. The computer-implemented method of claim 10 wherein generating personalized recommendations of valid deals to the target user comprises recommending the valid deals with the X number of highest γₙ values.

12. The computer-implemented method of claim 11 where X is equal to 3 to 20.

13. The computer-implemented method of claim 1 wherein keyword association rules comprises:
keyword pairs of keywords of purchased deals in the purchase data set;
for each keyword pair,
a support value which indicates a support for keyword the first keyword of the keyword pair,
a confidence value which indicates the confidence of the second keyword in the keyword pair given the first keyword or the keyword pair.

14. The computer-implemented method of claim 13 wherein generating personalized recommendations comprises recommending valid deals with X highest relevancy factor values.

15. A deals recommendation system comprising:
a data source, wherein the data source comprises a purchase data set containing purchased deals of users; and
an analyzer, the analyzer
analyzes the purchase data set to generate keyword association rules,
computes target weights for valid deals available for purchase by a target user based on the keyword association rules, purchase history of deals purchased by the target user, and valid deals, and
generates personalized recommendations of valid deals to the target user based on relevancy factors of the valid deals.

16. The system of claim 15 wherein the analyzer comprises:
a pre-processing module for pre-processing the purchase data set to extract keywords from purchased deals, the pre-processing generates a set of keywords for the purchased deals;
a rules module, the rules module
determines keyword pairs from the purchased deals by analyzing the set of keywords, and
generates keyword association rules of keyword pairs;
a weight module for assigning target weights to keyword pairs of valid deals based on keyword association rules; and
a recommendation module, the recommendation module generating recommendations of valid deals to the target user based on keyword association rules, deals purchased by the target user and valid deals.

17. The system of claim 16 wherein the weight module assigns target weights by:
determining deals available for sale, wherein a set of valid deals is D_{T}={d₁^{T}, . . . d₂^{T}, . . . d_{δ(T)}^{T}}, where δ(T) is the number of valid deals at time T;
determining valid deal keywords from each valid deal, when keywords of a valid deal Vdₙ, where keywords VWₙof a valid deal Vdₙ is VWₙ={Vω₁ⁿ, . . . Vω₂ⁿ, . . . Vω_{θ(n)}ⁿ},
where θ(n) is the number of words in valid deal Vdₙ;
determining keywords (target keywords) from a deal list (target deal list) of the target user, where set of target keywords Wₗ of deals in the purchase history of the target user is Wₗ={ω₁¹, . . . ωθ(1)¹, ω₁², . . . ω_{θ(2)}², . . . ω₁^{δ(l)}, . . . ω_{θ(δ(l))}^{δ(l)}}={ω₁^{T}, . . . ωθ̅^{T}},
where
T is the time related to all past purchases of the target user uₗ,
δ(l) is the number of deals purchased by uₗ, and
θ(δ(l)) is the number of words in the (δ(l)−^{th} deal purchased by uₗ; and
for each valid deal Vdₙ, where n is from 1 to N,
calculating target weight αₙ, where αₙ=Σᵣ₌₁^{θ(n)} Σ_{q=1}^{θ̅ C(ω}ᵣⁿ, ω_{q}^{T}), where C(ω, ω′) is the confidence value of word pair {ω, ω′}.

18. The system of claim 117 wherein the recommendation module determines relevancy factor of the valid deals to generate the recommendations to the target user.

19. The system of claim 18 wherein the relevancy factor γₙ for Vdₙ is γₙ=nαₙ+n_{βn},
where
nαₙ is a normalized target weight, and
nβₙ is a normalized quantity value of Vdₙ sold.

20. A non-transitory computer-readable medium having a stored thereon program code, the program code executable by a computer for generating recommendation of deals comprising:
providing a data source, wherein the data source comprises a purchase data set containing purchased deals of users; and
analyzing the purchase data set to generate keyword association rules which comprises
determining keyword pairs of deals purchased by users in the purchase data set,
for each keyword pair,
determining a support value which indicates a support for the first keyword of the keyword pair,
determining a confidence value which indicates the confidence of the second keyword in the keyword pair given the first keyword of the keyword pair.
computing target weights for valid deals available for purchase by a target user based on keyword association rules, purchased deals by the target user, and valid deals; and
generating personalized recommendations of valid deals to the target user based on relevancy factors of the valid deals.
